(19) United States
(12) Patent Application Publication
(10) Pub. No.: US 2016/0262513 A1
(43) Pub. Date: Sep. 15, 2016

(54) PROTECTIVE CASES

(71) Applicant: olloclip, LLC, Huntington Beach, CA (US)

(72) Inventor: Patrick D. O'Neill, Huntington Beach, CA (US)

(21) Appl. No.: 15/065,153

(22) Filed: Mar. 9, 2016

Related U.S. Application Data
(60) Provisional application No. 62/130,468, filed on Mar. 9, 2015.

(51) Int. Cl. A45C 11/00; H04M 1/18; H04B 1/3888

(52) U.S. Cl. CPC A45C 11/00; H04B 1/3888; H04M 1/185; A45C 2011/002; A45C 2011/003

(57) ABSTRACT

Some embodiments disclosed herein relate to impact-mitigation cases for various devices, such as mobile electronic devices, cameras, lenses, etc. Impact-mitigation cases may be removably attachable by a user to a vulnerable device, and may provide a degree of impact-mitigation. Impact mitigation may be provided by a plurality of deformable and hollow impact-mitigation regions, each of the impact-mitigation regions comprising a reservoir and a constricted portion filled with a fluid or liquid.

### CROSS-REFERENCE TO RELATED APPLICATION

This application claims the benefit of U.S. Provisional Patent Application No. 62/130,468, filed on Mar. 9, 2015 and entitled “Protective Cases,” the entire contents of which are hereby incorporated by reference herein and made part of this specification for all that they disclose.

### BACKGROUND OF THE INVENTIONS

1. Field

This disclosure relates generally to protective cases and specifically to protective cases for high-value or sensitive products that may be vulnerable to impact or other damage.

2. Description of the Related Art

People often carry, store, and use sophisticated and sensitive equipment and/or computing devices, such as mobile electronic devices (e.g., mobile phones, smart phones, tablet computers, wearable computers such as smart watches or glasses, ear pieces, etc.), cameras, lenses, construction or measuring or adjustment tools, inventory devices, etc. These devices can be vulnerable to damage from impact or from other situations, such as ingress of damaging materials (e.g., dust, dirt, water, or other liquid).

### SUMMARY

In some embodiments, protective cases are disclosed that can protect against or resist damage to a vulnerable device. Some examples include cases that provide a plurality of contact regions with interconnecting air channels to transfer and dissipate potentially damaging forces away from an impact zone. In some embodiments, protective cases can provide a barrier that is water resistant and/or resistant to ingress of damaging particles such as dust or other debris.

### BRIEF DESCRIPTION OF THE DRAWINGS

FIGS. 1A, 1B, 1C, and 1D illustrate upper perspective views of various embodiments of cases for a mobile electronic device.

FIGS. 2A and 2B illustrate perspective views of a protective case and a mobile electronic device that are initially separated and then attached to each other.

FIGS. 3A, 3B, and 3C illustrate front perspective views and a front plan view of a protective case and a camera that are initially separated and then attached to each other.

FIGS. 4A, 4B, 4C, and 4D illustrate front and rear perspective views and a partial front plan view of a protective case and a lens.

FIGS. 5A, 5B, 5C, and 5D illustrate another example of a protective case that is initially separated from and then attached to a mobile electronic device.

FIGS. 6A, 6B, and 6C illustrate another example of a protective case that is initially separated from and then attached to a mobile electronic device.

These drawings merely show certain examples and should not be considered to limit the inventions disclosed herein. The proportions and relative dimensions and sizes of each component as shown in these drawings forms part of the supporting disclosure of this specification, but should not be limiting on the scope of this specification, except to the extent that such proportions, dimensions, or sizes are included in any individual claims.

### DETAILED DESCRIPTION

Many types of high-performance, rugged, and/or damage-resistant cases can be used in accordance with embodiments of the inventions disclosed in this specification. Some examples of such cases are provided in U.S. Patent Application Publication No. 2014/0226268, entitled “Cases for Mobile Electronic Devices For Use With Auxiliary Lenses,” which was published on Aug. 14, 2014, and is incorporated by reference in this specification in its entirety. No feature illustrated and/or described in this specification is necessary or indispensable; rather, any can be omitted in any particular embodiment.

Any individual feature, step, structure, material, or method illustrated and/or described in any embodiment in this specification can be used in combination with or instead of any individual feature, step, structure, material, or method illustrated and/or described in any other embodiment in this specification, including in U.S. Patent App. Pub. No. 2014/0226268. For example, without limitation, any case or any portion thereof that is disclosed and/or illustrated in this specification can be used in connection with any case, or any portion thereof, that is configured to receive an auxiliary device (e.g., an auxiliary lens) on a mobile electronic device, such as is disclosed in one or more of the examples in U.S. Patent App. Pub. No. 2014/0226268.

The cases disclosed in this specification can be used to protect any type of vulnerable device. Some of the figures illustrate examples of vulnerable devices in the form of mobile electronic devices (e.g., mobile phones), lenses, and cameras, but any other type of vulnerable device can be protected using any of the cases, or portions thereof, that are disclosed in this specification. Any reference to any particular type of vulnerable device in this specification should be understood to refer to and be applicable to all types of vulnerable devices.

In many situations, vulnerable devices can be susceptible to damage from various types of impact, such as when dropped or bumped into something else. Some vulnerable devices include rigid housings that can be prone to chipping or cracking or fracturing, fragile viewing screens or user interfaces, electronic input or output ports, microphones, speakers, lenses, electronics, and/or other vulnerable structures that can be damaged, impaired, or rendered aesthetically undesirable by an impact event. A vulnerable device in a protective case can be referred to as a protected device. Protective cases may not prevent damage from all types or degrees of impact, but protective cases can provide an increased level of protection for protected devices to avoid certain damage that would be caused by the same impact event on a vulnerable device without a protective case.

In some embodiments, to help mitigate the effects of impact and to resist damage to vulnerable devices, a protective case for a vulnerable device can be configured to: (i) transfer one or more component forces, or portions thereof, associated with an impact event away from an impact zone of a protected device; (ii) diffuse one or more component forces associated with an impact event over a larger area than the area of the impact zone of the protected device by itself; and/or (iii) increase the time during which an amount of energy of impact is transferred to a protected device during an impact event. Any or all of these advantages can be achieved in any appropriately configured embodiments disclosed in this specification, although none of these advantages are required in all embodiments. In some embodiments, the protective cases may be removably attached to the vulnerable device by a user. For example, a protective case may not be integrated with or permanently coupled to the housing of a vulnerable device, but may instead be removably attached to the housing of the vulnerable device by a user without the need for specialized tools and/or additional fasteners.

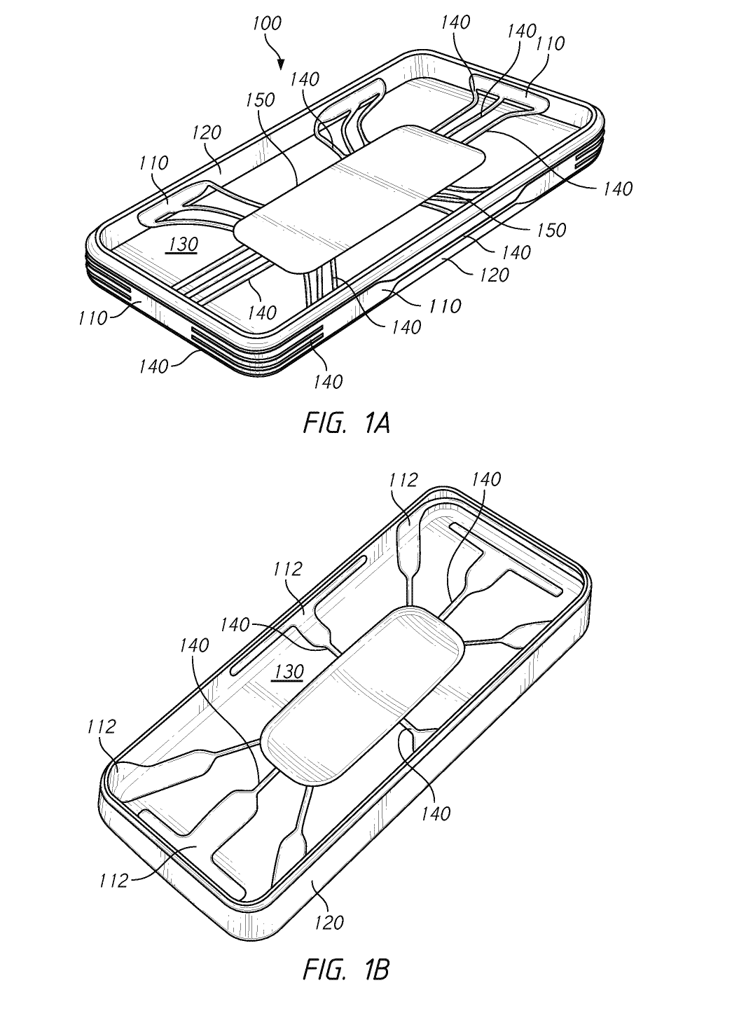

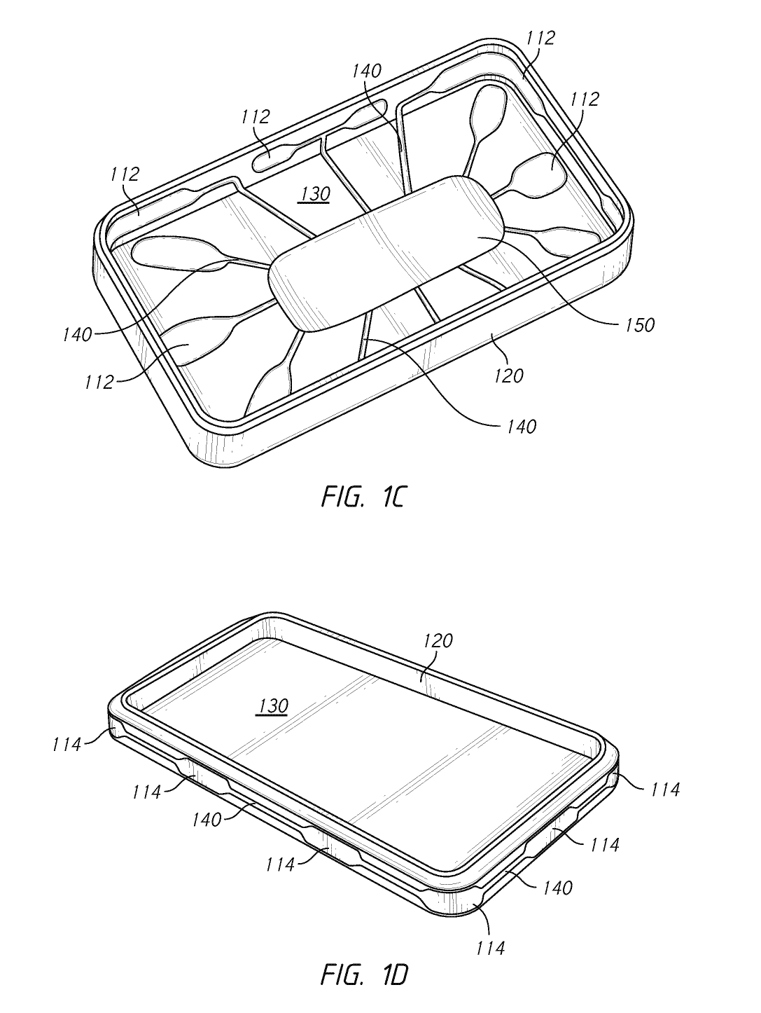

As illustrated in FIGS. 1A-1D, in some embodiments, a protective case 100 can comprise a base portion 120, an internal cavity 130 configured to receive a vulnerable device, and one or more external impact-mitigation regions 110 positioned on an external surface of the case 100. The base portion 120 can be generally rigid or generally flexible. In some embodiments, as shown, a plurality of impact-mitigation regions 110 can be positioned in various locations on one or more surfaces of the case 100. Some impact-mitigation regions 110 can be positioned on a plurality of both external and internal surfaces of the case 100, such as by extending through an aperture or groove or slot on the base portion 120 of the case 100. As shown in FIGS. 1B and 1C, some impact-mitigation regions 112 can be positioned on only internal surfaces of the case 100. As shown in FIG. 1D, some impact-mitigation regions 114 can be positioned on only external surfaces of the case 100. In some embodiments, as shown, at least one or two or more impact-mitigation regions 110, 112, 114 can be positioned on or along a plurality of different sides or edges and/or faces of a protective case 100 such that one or more surfaces of the case have a regular or uniform pattern or density of impact-mitigation regions positioned thereon. In some embodiments, a majority of the surface area of the external and/or internal surfaces of a case 100 can comprise one or more impact-mitigation regions 110, 112, and/or 114. Although the description that follows may refer to impact-mitigation region 110, impact-mitigation region 112, or impact-mitigation region 114 alone, it should be understood that in many cases the description may also or alternatively apply to any other impact-mitigation region or some subset thereof.

In some embodiments, one or more of the impact-mitigation regions 110 can be positioned in locations that are highly likely regions of contact between the protected device and something else (e.g., the ground) during an impact event, such as at one or more corner regions or end regions or edges or at one or more protrusions. In some embodiments, one or more of the external impact-mitigation regions 110, 114 can comprise at least a portion that extends peripherally further out away from the internal cavity 130 than the base portion 120 of the case 100 so that the one or more impact-mitigation regions 110 will more likely contact a large-size impact object or the ground or floor before or instead of the base portion 120 of the case 100; and/or one or more of the internal impact-mitigation regions 110, 112 can comprise at least a portion that extends peripherally further in toward the internal cavity 130 than the base portion 120 of the case 100 so that the one or more impact-mitigation regions 110, 112 will more likely contact a portion of a vulnerable device internally before or instead of the base portion 120 of the case 100. A larger-size impact object can be one that is larger than the distance between adjacent impact-mitigation regions 110.

Any or all of the impact-mitigation regions 110, 112, 114 can comprise a flexible, compressible, resilient, and/or soft region or outer portion, which in some embodiments is generally hollow and/or includes an interior cavity filled with a fluid such as air or a liquid such as water or any other suitable fluid or liquid. As used herein, the term “air” refers to any suitable gas, and includes but is not limited to ambient gas in the general environment. In addition, although this specification may refer separately and individually to fluid and/or liquid, it should be understood that any description of the use of a fluid may also or alternatively apply to liquid unless expressly stated otherwise. One or more of the impact-mitigation regions 110 can be made in whole or in part of silicone, rubber, latex, soft plastic, gel, foam, or any other material configured to flex, compress, expand, or bend in response to an impact event. One or more impact-mitigation regions 110 can be solid or substantially solid, especially if made of a resilient, flexible, compressible, expansive, or bendable material.

One or more of the impact-mitigation regions 110, 112, 114 can be in fluid communication with one or more transfer channels 140. As illustrated, the one or more transfer channels 140 can be configured to transfer fluid or liquid, such as air or water, between one or more regions of the case 100. For example, a transfer channel 140 can be configured to enable transfer of fluid or liquid between multiple impact-mitigation regions 110, 112, 114, as illustrated; and/or a transfer channel 140 can be configured to enable transfer of fluid or liquid between one or more impact-mitigation regions 110, 112, 114 and one or more main reservoirs 150 of fluid or liquid. A plurality of transfer channels 140 can extend generally in parallel with each other and/or can extend between the same source and destination structures (e.g., a particular set of impact-mitigation regions 110, 112, 114 and/or a main reservoir 150) to provide flow, or fluid or liquid exchange, along multiple paths between such structures. As illustrated, a main reservoir 150 can be located in a central portion of the case 100. In some embodiments, as shown, a plurality of transfer channels 140 can be in fluid or liquid communication with the same main reservoir 150. In some embodiments, as shown, the width of a transfer channel 140 can be much smaller than the smallest interior width of either an impact-mitigation region 110, 112, 114 and/or a main reservoir 150 that is in fluid communication with the transfer channel 140, such that the transfer channel 140 can create a constriction that provides resistance against fluid or liquid flow outside of an impact-mitigation region 110, 112, 114 or main reservoir 150 that is greater than the resistance to fluid or liquid flow within the same impact-mitigation region 110, 112, 114 or main reservoir 150. As shown, the main reservoir 150 can have an internal volume that is substantially larger than the internal volumes of the impact-mitigation regions 110, 112, 114, either individually or in aggregations or two or more impact-mitigation regions 110, 112, 114. As illustrated in FIGS. 1A-1D, a network of fluid or liquid reservoirs comprising a plurality of impact-mitigation regions 110, 112, 114 and/or main reservoirs 150 can be interconnected with each other by way of a plurality of transfer channels 140 to form an integral or unitary, impact-mitigation, fluid or liquid storage and transfer system.

The impact-mitigation regions 110, 112, 114, the main reservoirs 150, the transfer channels 140, and/or a network of one or more of such components can be formed in many different ways. For example, one or more of these structures can be formed by co-molding a soft, flexible, and/or resilient material onto a hard or rigid base 120; and or one or more of these structures can be formed by molding or otherwise forming depressions or recesses or protrusions directly into the base 120 (which itself can be soft, flexible, and/or resilient, or hard or rigid in some situations). In some embodiments, any or all of these structures can be molded or otherwise formed as a separate structure that is inserted or adhered to one or more other components of the case. In some embodiments, any or all of these structures can form a sealed, self-contained, sprawling structure that is fluid- or liquid-filled. In some embodiments, these structures form one or more open regions that contact or surround or seal against the exterior body of the vulnerable device itself.

In the event of an impact in which the protected device falls to the ground or strikes another object, external contact between an external impact-mitigation region 110 and another object can cause this impact-mitigation region 110 to bend, flex, buckle, compress, or otherwise deform. The deformation can convert at least a portion of the impact energy into motion or heat in the impact-mitigation region 110, thereby lowering the amount of impact energy that is transferred through the case 100 to a vulnerable device contained within the cavity 130 of the case 100.

In some embodiments, as shown, if an impact is sufficiently strong that it would effectively overpower an individual impact-mitigation region 110 by providing more impact energy than could be handled or absorbed in that region by deformation or otherwise within the impact-mitigation region 110 itself without causing damage to the vulnerable device, then a significant amount of fluid or liquid inside of the impact-mitigation region 110 may be forced out through one or more transfer channels 140 to another impact-mitigation region 110 and/or to a main reservoir 150. The constriction of the transfer channels 140 can help to ensure that fluid or liquid does not flow out too quickly or in too large of a volume during a normal impact event, without providing an effective impact-mitigation effect. According to the Venturi effect, in some embodiments, fluid or liquid flowing through a constriction will increase in speed and decrease in pressure, while fluid or liquid on both sides of the constriction will exert a pressure against the region of the constriction. In some embodiments, the deformation of an impact-mitigation region 110 diminishes the internal volume of the impacted impact-mitigation region 110 and/or compresses a fluid or liquid contained inside of such impact-mitigation region 110, creating a high-pressure region inside of the deformed portion of the impact-mitigation region 110 and forcing fluid or liquid out of the impact-mitigation region 110 and toward one or more adjacent lower-pressure regions in the network of fluid or liquid reservoirs or the fluid or liquid storage and transfer system. Any region of the network of fluid or liquid reservoirs or any region of the fluid or liquid storage and transfer system that receives fluid or liquid from an impacted and/or deformed region during an impact event can be configured to temporarily expand to accommodate such influx of additional fluid or liquid. Such expansion can divert or transform additional energy from the impact that could otherwise be transferred to and cause damage to the vulnerable device.

As illustrated, in some embodiments, one or more of the impact-mitigation regions 112 are positioned only on an inside surface of the case 100. This type of impact-mitigation region 112 does not interface or make contact directly with an impact object, but instead helps to cushion the vulnerable device inside of the cavity 130, diminishing the transfer of energy between the vulnerable device and the base 120 during an impact event.

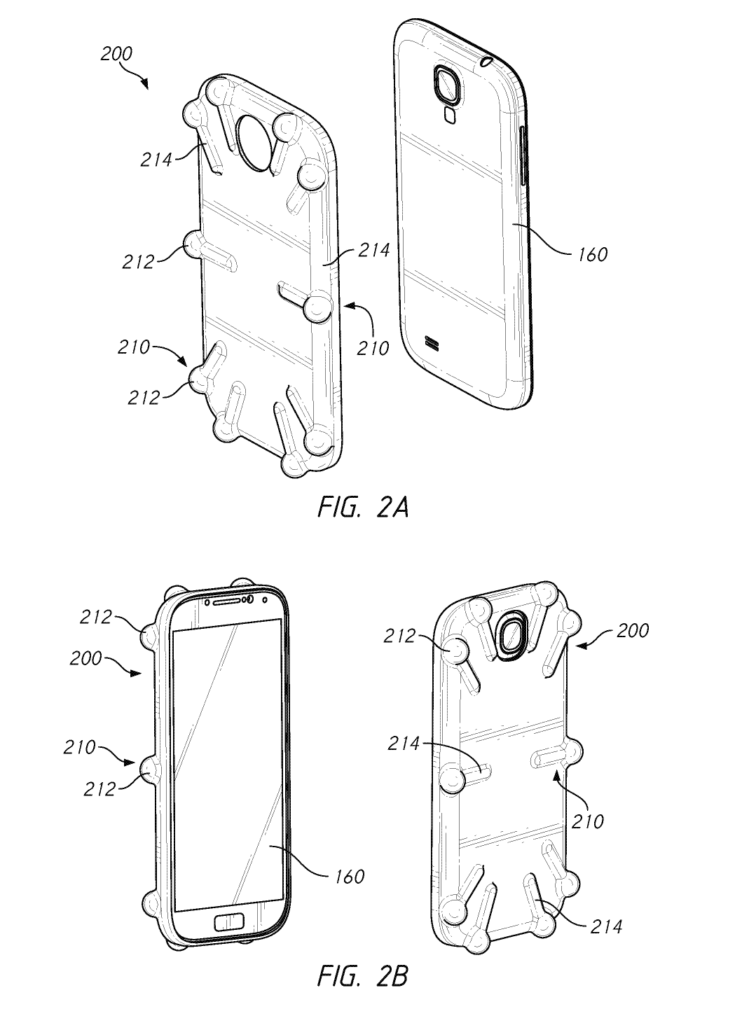

As shown in FIGS. 2A-2B, 3A-3C, and 4A-4D, a case 200, 208, 300 can be utilized to resist damage from an impact against various types of vulnerable devices, including mobile phones 160 and lenses 207 and cameras 205, such as highly portable adventure cameras (e.g., the GoPro camera), which are frequently put in positions of high risk of damage.

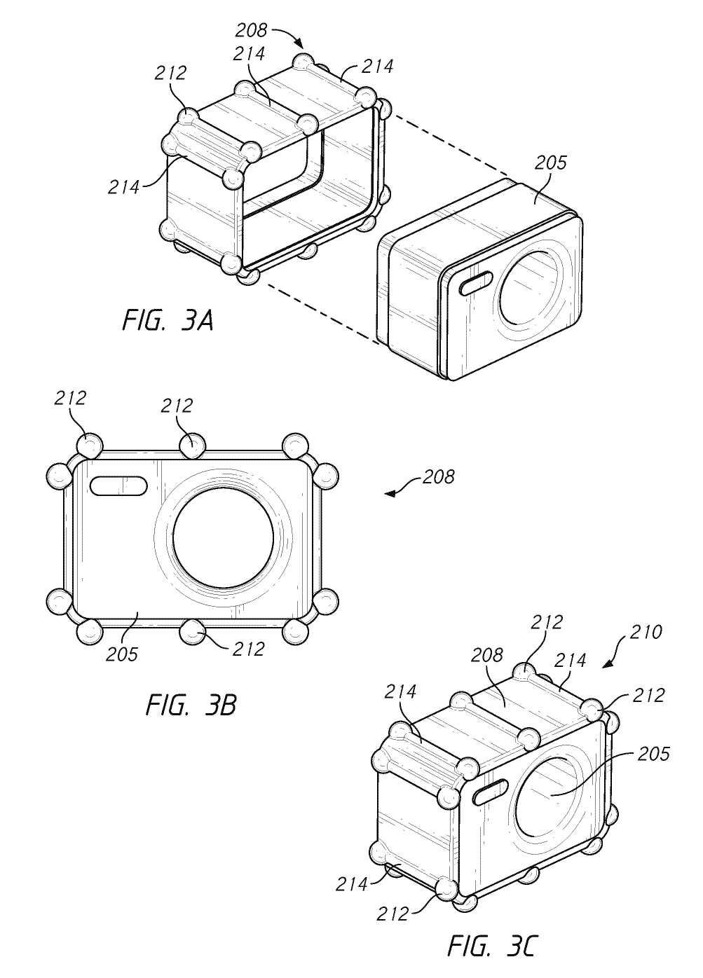

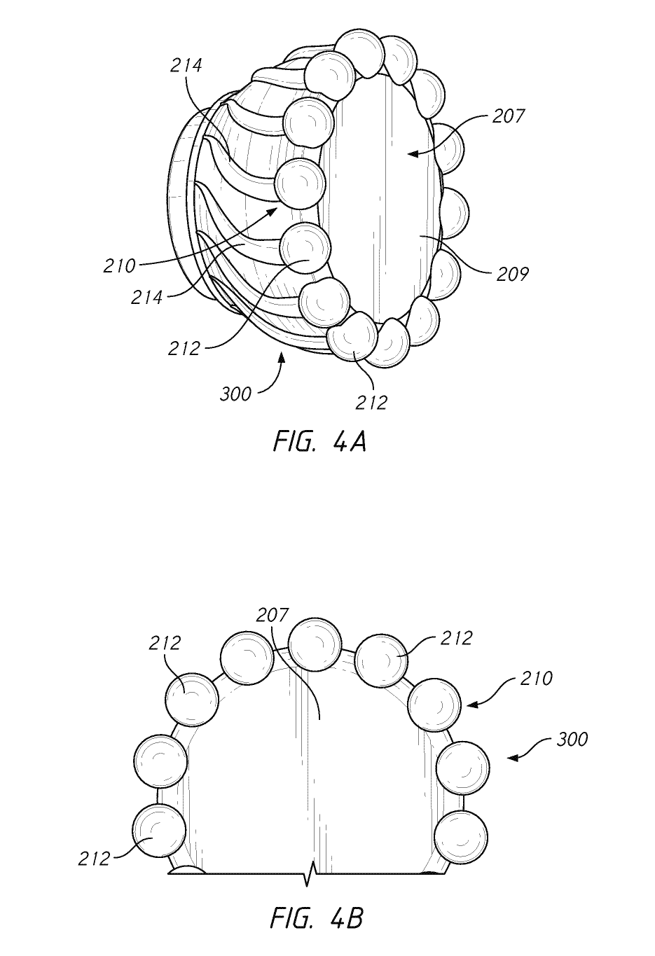

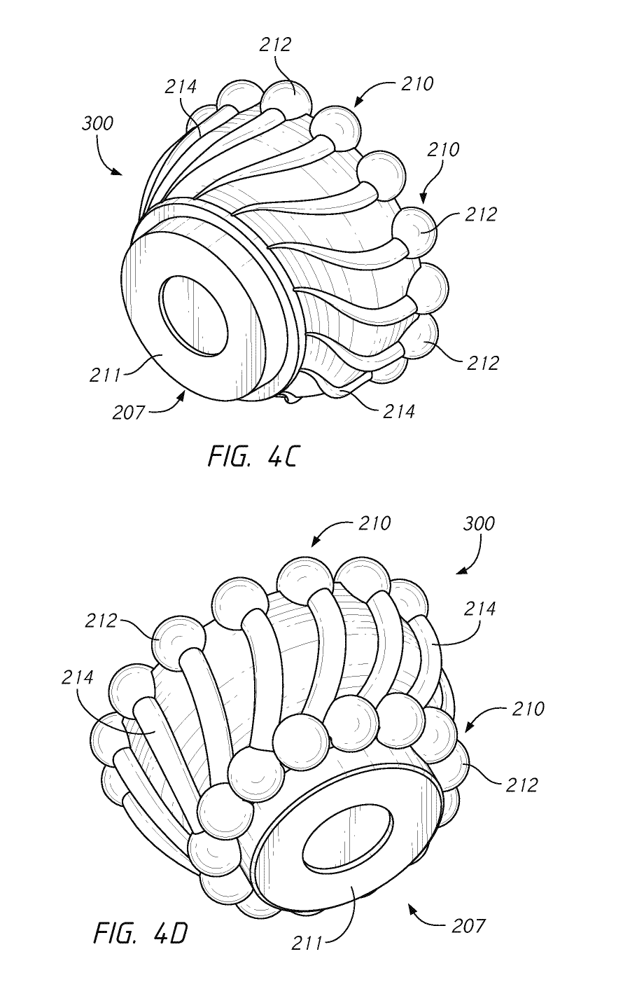

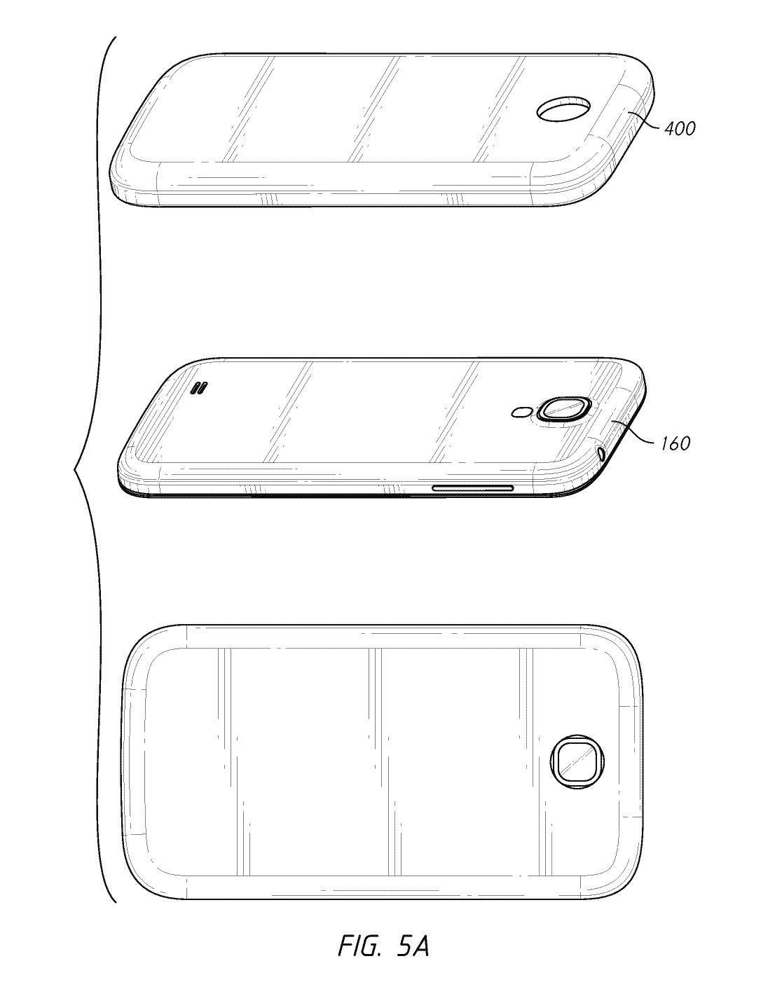

In some embodiments, as illustrated in FIGS. 2A and 2B, some protective cases 200 can generally surround a mobile phone 160 on a plurality of sides (e.g., any one or more of the back face, front face, left-side edge, right-side edge, top edge, and/or bottom edge). As illustrated in FIGS. 3A-3C and 4A-4D, some protective cases 208, 300 can generally surround a camera 205 or a lens 207, respectively. The cases 200, 208, 300 can comprise a plurality of impact-mitigation regions 210. As with all components in this specification, any of the structures, materials, features, or steps of any other impact-mitigation regions that are illustrated or described in this specification can be used instead of or in addition to the impact-mitigation regions 210.

Any one or all of the impact-mitigation regions 210 can comprise at least one reservoir region 212, such as a head or a generally spherical bulb, and at least one constricted region 214 that is or are in fluid or liquid communication with the reservoir region 212. The reservoir region 212 and/or the constricted region 214 can be solid or hollow. In some embodiments, the impact-mitigation regions 210 can be hollow and can contain a fluid or liquid such as air or water. At least an exterior surface of the reservoir region 212 can be made of a flexible or resilient or soft material that flexes, bends, compresses, or otherwise deforms upon impact. When an impact event occurs, at least a portion of the energy of impact can be converted into deformation of the reservoir region 212, thereby diminishing the energy of impact that is transferred to the vulnerable device itself. As an impact event progresses, in some embodiments, the reservoir region 212 can transfer internally contained fluid or liquid into one or more other regions of the case 200, such as into one or more of the constricted regions 214. As illustrated, a diameter or cross-sectional width of the reservoir region 212 can be substantially larger than a transverse diameter or cross-sectional width of the constricted region 214. In some embodiments, the internal volume of one or more of the constricted regions 214 can be about equal to or greater than the internal volume of one or more of the reservoir regions 212. Any feature, step, structure, material, or method described and/or illustrated in connection with FIGS. 1A-1D and 2A-2B can be used instead of or in addition any feature, step, structure, materials, or methods described and/or illustrated in connection with FIGS. 3A-3C and 4A-4D.

As shown in FIGS. 2A-2B, 3A-3C, and 4A-4D, one or more of the reservoir regions 212 can be positioned on or along one or more outer edges and/or on or along one or more corner regions of the case 200, 208, 300. In some embodiments, as shown in FIGS. 2A-2B, one or more constricted regions 214 can extend from an external region or edge toward or to an internal region or edge. As shown, a plurality of impact-mitigation regions 210 can be generally oriented in an array such that each impact-mitigation region 210 comprises a longitudinal axis and a plurality of such axes are non-parallel and/or generally converge toward a central region or point on a surface of the case 200.

In some embodiments, as illustrated in FIGS. 3A-3C, the reservoir regions 212 can be positioned on opposing sides or edges of the same impact-mitigation region 210 with a constricted region 214 extending between each of these reservoir regions 212, such that the reservoir regions 212 are in fluid or liquid communication with each other, if the impact-mitigation region 210 is hollow. As shown, the impact-mitigation region 210 can extend further outward in a peripheral direction than the case 200, 208, 300 such that an impacting external object that is greater in size than the distance between adjacent impact-mitigation regions 210 will strike an impact-mitigation region 210 before or instead of the base portion of the case 200, 208, 300. In some embodiments, as shown in FIGS. 3A-3C, an array of impact-mitigation regions 210 can be generally aligned along one or more edges of a case 208 generally parallel to each other and/or generally parallel with the thickness of the case 208 from front to back.

As shown in FIGS. 4A-4D, an array or a plurality of generally parallel impact-mitigation regions 210 can be located and oriented generally circumferentially around a case 300 at generally constant intervals to provide generally equal protection around the entire periphery of the case 300. In some embodiments, the case 300 may be substantially cylindrical, substantially conical, substantially cubic, substantially the shape of a parallelepiped, or some combination thereof, or shaped in some other manner that closely corresponds to the outer shape of a lens 207 or other vulnerable device to be protected. For example, as shown, the case 300 can be made of a resilient or flexible material that is configured to expand to receive and contract to tightly hold a lens 207 that comprises a wider, heavier end 209 and a narrower, lighter end 211. The reservoirs 212 of impact-mitigation regions 210 can be positioned at or near an end of the case 300 that is configured to receive the wider-heavier end 209 of the lens 207, since in a falling impact the protected device is more likely to hit the ground on this side. In some embodiments, as illustrated in FIG. 4D, the reservoir regions 212 can be positioned on opposing sides or edges of the same impact-mitigation region 210 with a constricted region 214 extending between each of these reservoir regions 212, such that the reservoir regions 212 are in fluid or liquid communication with each other, if the impact-mitigation region 210 is hollow.

In some embodiments, all of the impact-mitigation regions 210 or some subset thereof (e.g., two or more impact-mitigation regions 210) may be connected such that fluid or liquid from one impact-mitigation region 210 may overflow into another impact-mitigation region 210 during an impact event. For example, a hollow transfer channel or an additional constricted region (not shown) may be formed along the circumference of the case 300 and may facilitate fluid and/or liquid communication between various impact-mitigation regions 210, such as between different constricted regions 214 and/or between different reservoir regions 212. In some embodiments, an impact-mitigation region 210 may include or be in communication with a pressure-relief region (e.g., a vent or a valve) that allows fluid and/or liquid to be expelled or to otherwise escape into the environment during or shortly after an impact event. For example, a constricted region 214 may extend from a reservoir region 212 at one end to a pressure relief region at a second end of the constricted region 214.

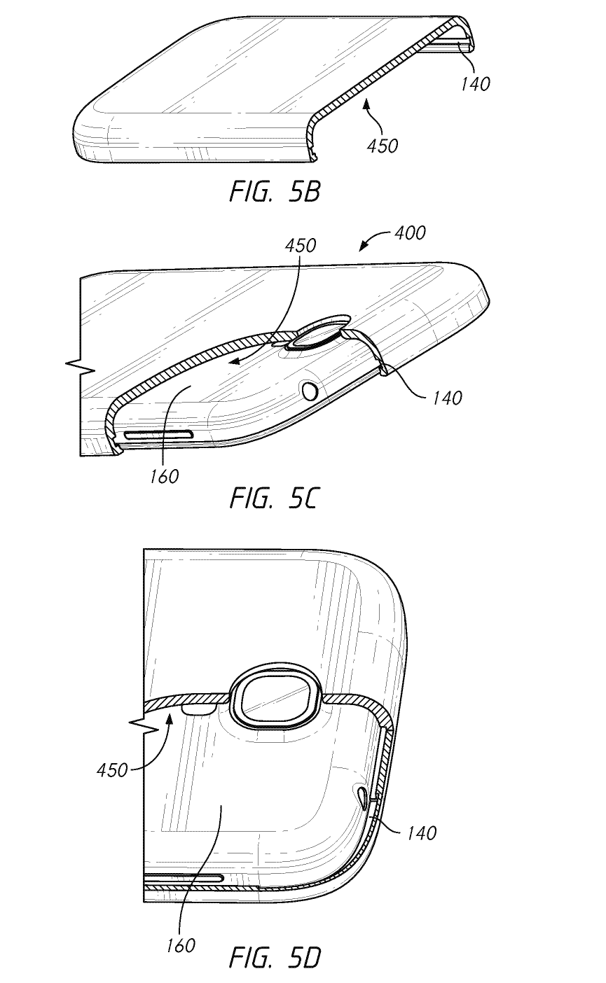

In some embodiments, as illustrated in FIGS. 5A-5D, a protective case 400 can comprise a main reservoir 450 that is formed between a face of the vulnerable device (e.g., a phone 160) and a face of the case 400. In the detached stage, the reservoir 450 is a concave space formed in the protective case 400. A transfer channel 140 can be provided along all or a portion of the inside periphery of the case 400 to facilitate transfer of fluid around the phone 160 and/or to permit controlled escape of fluid or liquid from the main reservoir 450 to ambient during an impact event. As with all embodiments in this specification, any feature, step, structure, material, or method described and/or illustrated in connection with FIGS. 5A-5D can be used with or instead of any other feature, step, structure, material, or method described and/or illustrated elsewhere in this specification.

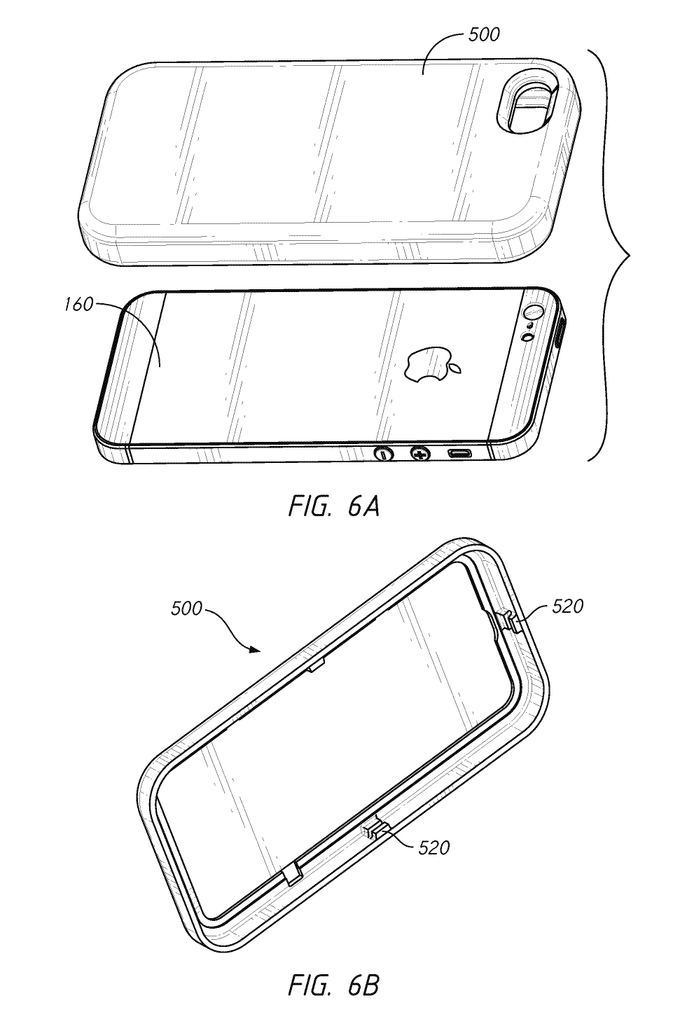

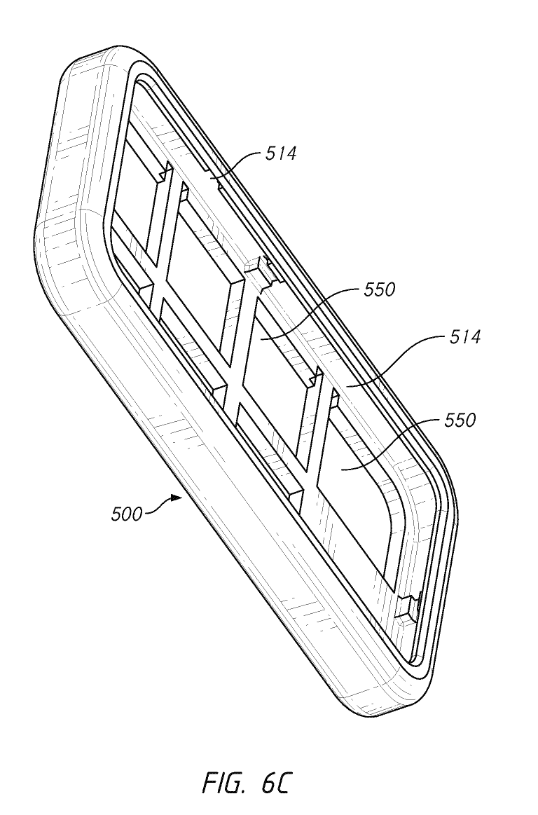

As shown in FIGS. 6A-6C, another embodiment of a case 500 can comprise a plurality of main reservoirs 550 with generally parallel sides arranged in a grid pattern on one or more faces of the case 500. One or more transfer channels 514 can provide communication between ambient and one or more of the main reservoirs 550 during an impact event and/or one or more transfer channels 514 can provide a peripheral band for the transfer of fluid or liquid along or around the periphery of the case 500 to provide impact protection around a majority of the case 500 or around virtually the entire case 500. The case 500 can be made of a flexible material that is configured to be expanded or stretched or bent around a vulnerable device, such as a mobile phone, and that is configured to thereafter constrict or contract to tightly grip the vulnerable device.

In some embodiments, as shown, one or more flexible spacers or positioning protrusions 520 can be provided on or along an internal periphery of the case 500 to help in positioning and securing a vulnerable device within a cavity of the case 500. The spacers or protrusions 520 can help to secure the vulnerable device in place during use, but can deform (e.g., bend, flex, compress, etc.) during impact to permit the vulnerable device to flexibly or resiliently shift and/or to permit air or another fluid or a liquid to escape from the space between the internal surface of the case 500 and the exterior of the vulnerable device when such space is compressed or otherwise deformed during impact.

Any of the embodiments in this specification, or combinations of features from different embodiments in this specification, may be manufactured according to various methods. For example, a method of manufacturing an impact-mitigation case may include providing a case with a base portion and a plurality of impact-mitigation regions positioned on an exterior surface of the base portion. The provided base portion may also include a main reservoir and a plurality of transfer channels extending between one or more impact-mitigation regions to the main reservoir. As another example, a method of manufacturing an impact-mitigation case may include providing a base portion having a plurality of deformable and hollow impact-mitigation regions, each of the impact-mitigation regions comprising a reservoir and a constricted portion filled with a fluid or liquid, wherein, upon an impact event, a portion of an impacted impact-mitigation region is configured to deform, and fluid or liquid within the deformed portion of the impacted impact-mitigation region is configured to flow to another portion of the impacted impact-mitigation region, thereby absorbing energy from the impact.

In any embodiment in this specification, the structures or systems described and/or illustrated can be positioned internally rather than externally or can be covered by one or more layers of other material (e.g., an additional flexible material such as silicon rubber, or a plastic, a metal, a fabric, or a leather, etc.) to provide additional or alternative cushioning or other impact-resistant material or to alter the aesthetic appearance of the device. In some embodiments, any device described and/or illustrated in this specification can be provided with water-resistant and/or dust- or particle-resistant structures or cases or enclosures, such as any of those described and/or illustrated in U.S. Patent Application Publication No. 2014/0226268.

In some embodiments, any of the features, steps, structures, materials, or methods described and/or illustrated in this specification can be used on personal protection devices, such as one or more types of helmets, knee or elbow pads, shin guards, chest guards, etc., to help protect the body of a person during an impact event.

The following is claimed:

1. An impact-mitigation case for a mobile electronic device comprising:
a base portion;
a plurality of impact-mitigation regions positioned on an exterior surface of the base portion;
a main reservoir; and
a plurality of transfer channels extending between one or more impact-mitigation regions to the main reservoir.

2. A combination of the impact-mitigation case of claim 1 and the mobile electronic device.

3. The impact-mitigation case of claim 1, wherein the plurality of impact-mitigation regions are hollow.

4. The impact-mitigation case of claim 3, wherein the main reservoir is hollow.

5. The impact-mitigation case of claim 4, wherein the plurality of transfer channels are hollow.

6. The impact-mitigation case of claim 1, wherein the main reservoir comprises a fluid.

7. The impact-mitigation region of claim 6, wherein the fluid comprises at least one of a gas or a liquid.

8. The impact-mitigation case of claim 1, further comprising a pressure-relief region, wherein an impact-mitigation region of the plurality of impact-mitigation regions is in fluid communication with the pressure-relief region, and wherein upon an impact event a portion of fluid from the impact-mitigation region is expelled from the impact-mitigation case via the pressure relief region.

9. The impact-mitigation case of claim 1, wherein the volume of the main reservoir is substantially larger than the volume of one or more of the plurality of impact-mitigation regions.

10. The impact-mitigation case of claim 1, wherein one or more of the plurality of impact-mitigation regions are positioned on one or more of an edge, a corner, and end, or a protrusion.

11. The impact-mitigation case of claim 1, wherein the case is configured to removably receive a mobile electronic device.

12. The impact-mitigation case of claim 11, wherein the case is configured to removably receive a mobile phone.

13. An impact-mitigation case comprising:
a base portion; and
a plurality of deformable and hollow impact-mitigation regions, each of the impact-mitigation regions comprising a reservoir and a constricted portion filled with a fluid or liquid;
wherein, upon an impact event, a portion of an impacted impact-mitigation region is configured to deform, and fluid or liquid within the deformed portion of the impacted impact-mitigation region is configured to flow to another portion of the impacted impact-mitigation region, thereby absorbing energy from the impact.

14. The impact-mitigation case of claim 13, wherein the case is configured to receive one of: a mobile electronic device, a lens, or a camera.

15. The impact-mitigation case of claim 13, further comprising a main reservoir, wherein at least two of the plurality of impact-mitigation regions are in fluid or liquid communication with the main reservoir via corresponding hollow transfer channels.

16. The impact-mitigation case of claim 13, further comprising a hollow transfer channel, wherein at least two of the plurality of impact-mitigation regions are in fluid or liquid communication with each other via the hollow transfer channel.

17. The impact-mitigation case of claim 13, further comprising a peripheral band along a periphery of the base portion, wherein the peripheral band permits transfer of fluid or liquid around substantially all of the base portion.

18. The impact-mitigation case of claim 13, further comprising a pressure-relief region, wherein the impacted impact-mitigation region is in communication with the pressure-relief region, and wherein upon the impact event a portion of fluid or liquid from the impacted impact-mitigation region is expelled from the impact-mitigation case via the pressure relief region.

19. A method of manufacturing an impact-mitigation case, the method comprising:
providing a base portion; and
providing a plurality of deformable and hollow impact-mitigation regions, each of the impact-mitigation regions comprising a reservoir and a constricted portion filled with a fluid or liquid;
wherein, upon an impact event, a portion of an impacted impact-mitigation region is configured to deform, and fluid or liquid within the deformed portion of the impacted impact-mitigation region is configured to flow to another portion of the impacted impact-mitigation region, thereby absorbing energy from the impact.

20. The method of manufacturing of claim 19, further comprising providing a main reservoir, wherein at least two of the plurality of impact-mitigation regions are in fluid or liquid communication with the main reservoir via corresponding hollow transfer channels

21. The method of manufacturing of claim 19, further comprising providing a peripheral band along a periphery of the base portion, wherein the peripheral band permits transfer of fluid or liquid around substantially all of the base portion.

22. The method of manufacturing of claim 19, further comprising providing a pressure-relief region, wherein the impacted impact-mitigation region is in communication with the pressure-relief region, and wherein upon the impact event a portion of fluid or liquid from the impacted impact-mitigation region is expelled from the impact-mitigation case via the pressure relief region.
